(19) United States
(12) Patent Application Publication
(10) Pub. No.: US 2025/0254509 A1
(43) Pub. Date: Aug. 7, 2025

(54) SEAMLESS ROAMING IN A WIRELESS NETWORK

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US); Ken Kinwah Ho, San Jose, CA (US); Rui Cao, Sunnyvale, CA (US)

(21) Appl. No.: 19/188,569

(22) Filed: Apr. 24, 2025

Related U.S. Application Data
(63) Continuation-in-part of application No. 18/491,451, filed on Oct. 20, 2023.
(63) Continuation-in-part of application No. 18/499,783, filed on Nov. 1, 2023.
(63) Continuation-in-part of application No. 18/409,618, filed on Jan. 10, 2024.
(60) Provisional application No. 63/638,843, filed on Apr. 25, 2024.
(60) Provisional application No. 63/690,156, filed on Sep. 3, 2024.
(60) Provisional application No. 63/698,524, filed on Sep. 24, 2024.
(60) Provisional application No. 63/380,252, filed on Oct. 20, 2022.
(60) Provisional application No. 63/383,047, filed on Nov. 9, 2022.
(60) Provisional application No. 63/383,044, filed on Nov. 9, 2022.
(60) Provisional application No. 63/381,798, filed on Nov. 1, 2022.
(60) Provisional application No. 63/516,815, filed on Jul. 31, 2023.
(60) Provisional application No. 63/479,209, filed on Jan. 10, 2023.
(60) Provisional application No. 63/479,603, filed on Jan. 12, 2023.

(51) Int. Cl. H04W 8/08

(52) U.S. Cl. CPC H04W 8/08

(57) ABSTRACT

Seamless roaming in seamless mobile domain (SMD) of a wireless network includes receiving from an access point multi-link device (AP MLD) in the wireless network information of one or more candidate target AP MLDs to seamlessly roam to, the information including a seamless roaming domain element that identifies the seamless roaming domain of the one or more candidate target AP MLDs; selecting a target AP MLD from the one or more candidate AP MLDs based on the information; and roaming to the target AP MLD.

### CROSS-REFERENCE TO RELATED APPLICATIONS

This application claims the benefit of U.S. Provisional Patent Application Ser. No. 63/638,843 entitled “RESOURCE GUARANTEE UNDER SEAMLESS ROAMING” filed Apr. 25, 2024, U.S. Provisional Patent Application Ser. No. 63/690,156 entitled “SEAMLESS ROAMING PROCEDURE” filed Sep. 3, 2024, and U.S. Provisional Patent Application Ser. No. 63/698,524 entitled “SEAMLESS ROAMING PROCEDURE” filed Sep. 24, 2024, the contents each of which are incorporated herein by reference in its entirety. This application claims the benefit as a continuation-in-part of U.S. application Ser. No. 18/491,451 entitled “DISTRIBUTED ACCESS POINT MULTI-LINK DEVICE” filed Oct. 20, 2023 which claims the benefit of U.S. Provisional Patent Application Ser. No. 63/380,252 filed Oct. 20, 2022, U.S. Provisional Patent Application Ser. No. 63/383,047 filed Nov. 9, 2022, and U.S. Provisional Patent Application Ser. No. 63/383,044 filed Nov. 9, 2022. This application claims the benefit as a continuation-in-part of U.S. application Ser. No. 18/499,783 entitled “HANDSHAKE FOR SMOOTH ROAMING” filed Nov. 1, 2023 which claims the benefit of U.S. Provisional Patent Application Ser. No. 63/516,815 filed Jul. 31, 2023 and U.S. Provisional Patent Application Ser. No. 63/381,798 filed Nov. 1, 2022. This application claims the benefit as a continuation-in-part of U.S. application Ser. No. 18/409,618 entitled “ROAMING USING DISTRIBUTED ACCESS POINT MULTI-LINK DEVICE GROUP” filed Jan. 10, 2024 which claims the benefit of U.S. Provisional Patent Application Ser. No. 63/479,209 filed Jan. 10, 2023 and U.S. Provisional Patent Application Ser. No. 63/479,603 filed Jan. 12, 2023. The contents of each of these applications are incorporated herein by reference in its entirety.

### FIELD OF USE

The present disclosure relates generally to wireless networks, and more particularly, to a system, method, and apparatus for seamless roaming in the wireless network.

### BACKGROUND

A seamless mobile domain (SM D) with access point multi-link devices (AP MLDs) positioned at different locations in a wireless network allows for a non-AP MLD to smoothly roam within an area covered by the AP MLDs. The non-AP MLD roams from a serving AP MLD to another AP MLD referred to as a target AP MLD without disassociation and reassociation with the seamless mobile domain and a state 4 operation is maintained (class 3 frame exchanges such as data frames, management frames, and control frames are continued without reassociation) after the non-AP MLD sets up the association with the seamless mobile domain through the links of the serving AP MLD. The seamless roaming is possible because the non-AP MLD has already made an authentication and association with the seamless mobile domain through an AP MLD affiliated with the seamless mobile domain. Before exchanging data frames with the target AP MLD, a frame exchange context of the non-AP MLD is switched from the serving AP MLD to the target AP MLD and resources for the non-AP MLD are established. Further, a distributed system (DS) mapping change to the target AP MLD is performed and the non-AP MLD sets up link(s) to the target AP MLD. The non-AP MLD does the data frame exchanges with the target AP MLD after the seamless roaming is complete since the links of the non-AP MLD are only set up to the target AP MLD affiliated with the seamless mobile domain.

### BRIEF DESCRIPTION OF DRAWINGS

FIG. 1 illustrates an example of seamless roaming in a seamless mobile domain (SMD) of a multi-link wireless communications system in accordance with one or more embodiments.

FIG. 2 illustrates an example basic multi-link element to carry information of candidate AP MLDs in accordance with one or more embodiments.

FIG. 3 illustrates an example neighbor report element to carry information of candidate AP MLDs in accordance with one or more embodiments.

FIG. 4 illustrates an example reduced neighbor report (RNR) element to carry information of candidate target AP MLDs in accordance with one or more embodiments.

FIG. 5 is illustrates example signaling relating to selection of a target AP MLDs to which a non-AP MLD seamlessly roams in accordance with one or more embodiments

FIG. 6 illustrates additional example signaling for obtaining the information of the candidate AP MLDs in accordance with one or more embodiments.

FIG. 7 illustrates an example resource reservation element for the non-AP MLD to reserve a resource of a target AP MLD in accordance with one or more embodiments.

FIG. 8 illustrates example communication between the non-AP MLD and a plurality of AP MLD in the SMD to perform a seamless roaming process in accordance with one or more embodiments.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, “an example”, or similar language means that a particular feature, structure, or characteristic described in connection with the indicated embodiment is included in at least one embodiment of the present invention. Thus, the phrases “in one embodiment”, “in an embodiment”, “an example”, and similar language throughout this specification may, but do not necessarily, all refer to the same embodiment.

Several aspects of the disclosed WiFi system will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

Embodiments disclosed herein are directed to seamless roaming in a seamless mobile domain (SMD) (also known as roaming AP (access point) MLD (multi-link device)) by an AP MLD providing information for one or more candidate target AP MLDs to which a non-AP MLD is able to roam. In one or more embodiments, the AP MLD such as a serving AP MLD announces information of candidate target AP MLDs that the non-AP MLD is able to seamlessly roam to which includes an AP MLD identifier and SMD element which identifies the SMD. In some embodiments, the non-AP MLD provides service requirements of the non-AP MLD and based on the service requirements receives information of candidate target AP MLDs from which the non-AP MLD may select for seamless roaming. In some embodiments, the action frames for seamless roaming are sent to the target AP MLD through the serving AP MLDs for establishing links and frame exchange context transfer etc. when the serving AP MLD is reachable. In some embodiments, the action frames for seamless roaming are sent to the target AP MLD directly for establishing links and frame exchange context transfer etc. when the serving AP MLD is not reachable. Additionally, the non-AP MLD reserves a resource with the target AP MLD during a roaming preparing stage (link establishment and DS mapping change) or roaming execution stage while the roaming preparing stage is not used. Well known instructions, protocols, structures, and techniques have not been shown in detail in order not to obfuscate the description.

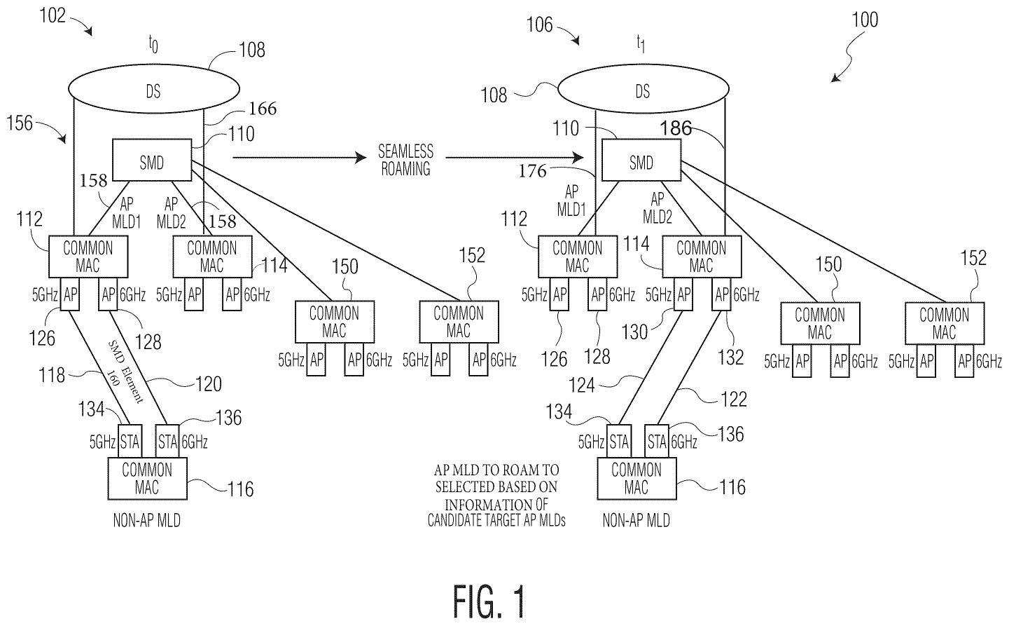

FIG. 1 illustrates an example of seamless roaming in a seamless mobile domain (SMD) of a multi-link wireless communications system in accordance with one or more embodiments. In the embodiment shown in FIG. 1, the multi-link communications system 100 includes a seamless mobile domain (SMD) 110 which includes a number of different affiliated AP MLDs 112, 114, 150, 152 in different physical locations that operate together and have a common medium access control (MAC) address to identify the SMD. The SMD 110 may communicate management information with an AP MLD via a respective management paths 158. In one or more embodiments, the AP MLDs 114, 112 may be virtual AP MLDs located in a respective AP device (also referred to as AP MLD device) positioned in different areas of the wireless network and any AP MLDs of an AP device may be located in a same area and affiliated with different SMDs. The multi-link communications system 100 also has a non-AP station (STA) MLD (non-AP MLD) 116 which is able to wirelessly communicate with one AP MLD (when roaming is done or no roaming happens), or one or more of the AP MLDs (during the roaming procedure). The AP MLDs 112, 114, 150 may be in a communication range to the non-AP MLD 116, while AP MLD 152 may not be in a communication range to the non-AP MLD 116. The multi-link communications system 100 may be used in various applications, such as industrial applications, medical applications, computer applications, and/or consumer or enterprise applications. In some embodiments, the multi-link communications system 100 may be a wireless communications system, such as a wireless communications system compatible with an Institute of Electrical and Electronics Engineers (IEEE) 802.11 protocol. For example, the multi-link communications system 100 may be a wireless communications system compatible with a IEEE 802.11bn protocol and various other iterations of the 802.11 specification are referred to herein including but not limited to IEEE 802.11ac, IEEE 802.11be, and IEEE 802.11ax. IEEE 802.11ac is referred to as very high throughput (VHT). IEEE 802.11ax is referred to as high efficiency (HE). IEEE 802.11be is referred to as extreme high throughput (EHT). IEEE 802.11bn is referred to as ultra-high reliability (UHR). A configuration of the multi-link communications system 100 is shown for different time instances t₀, t₁ while the non-AP MLD 116 performs a roaming between the neighbor AP MLDs of the seamless mobile domain 110.

The depicted multi-link wireless communications system 100 is shown with certain components and described with certain functionality herein, but the multi-link communications system 100 may include fewer or more components to implement the same, less, or more functionality. In some embodiments, the multi-link communications system 100 includes multiple associated non-AP MLDs. In some embodiments, an AP MLD may have a single affiliated AP. In some embodiments, a non-AP MLD may have a single affiliated STA. In some embodiments, the seamless mobile domain 102 may have more than four affiliated AP MLD or less than four affiliated AP MLD. In some embodiments, the non-AP MLD 116 may have a plurality of links to one or more respective AP MLDs to perform data communication. Although the multi-link communications system 100 is shown in FIG. 1 as being connected in a certain topology, the network topology of the multi-link communications system is not limited to the illustrated topology.

The seamless mobile domain 110 has AP MLD 112, AP MLD 114, AP MLD 150, AP MLD 152 which are collectively referred to herein as a distributed AP MLD group. In one or more embodiments, the distributed AP MLD group may be an extended service set (ESS) or part of an ESS. In some embodiment, some upper layer Media Access Control (MAC) functionalities (association, authentication, pairwise transient key (PTK) key negotiation, stream classification service (SCS) agreement, emergency preparedness communication service (EPCS) authorization, block acknowledgement (BA) agreement negotiation, MLD level power save of maximal idle period, etc.) are implemented in the seamless mobile domain 110. In some embodiments, some upper layer Media Access Control (MAC) functionalities (e.g., reordering of frames, STR/NSTR/MLSR/EMLSR, MLD level power save except maximal idle period, etc.) are implemented in a common MAC of an AP MLD 112, 114, 16 and the APs of the AP MLDs implement lower layer MAC functionalities (e.g., backoff, frame transmission, frame reception, etc.). The seamless mobile domain 110 and associated components illustrated in FIG. 1 may be implemented in hardware (e.g., circuits), software, firmware, or a combination thereof and fully or partially implemented as an integrated circuit (IC) device.

In one or more embodiments, AP MLD 112 may have APs 126, 128, AP MLD 114 may have APs 130, 132, and AP MLD 150 and AP MLD 152 may also have corresponding APs. Those APs in a signal range may be neighbor APs. In some embodiments, the APs may be wireless APs compatible with at least one WLAN communications protocol (e.g., at least one IEEE 802.11 protocol) and be implemented in hardware (e.g., circuits), software, firmware, or a combination thereof. The APs may be fully or partially implemented as an IC device and in some embodiments one or more APs may be virtual APs. In some embodiments, each physical AP includes at least one antenna, at least one transceiver operably connected to the at least one antenna, and at least one controller connected to the corresponding transceiver. In some embodiments, each physical AP affiliated with an AP MLD includes multiple RF chains and the at least one transceiver in a PHY circuit of the AP. The at least one controller may be configured to control the at least one transceiver to transmit and receive frames. In some embodiments, the at least one controller may be implemented within a processor, such as a microcontroller, a host processor, a host, a DSP, or a CPUs. In one or more embodiments, each of the APs may define different basic service set (BSS) operating channel operating in different frequency bands. The APs may operate in one of a 5 GHz or 6 GHz band. In one or more embodiments, the AP MLD 112 includes a 5 GHZ AP 126 and 6 GHZ AP 128. The AP MLD 114 includes a 5 GHz AP 130 and 6 GHz AP 132.

Each of AP MLDs 112, 114, 150, 152 may be further coupled to a distribution system (DS) 108 which could be an Ethernet switch or access server which facilitates data communication with a local area network (e.g., a LAN) or a backbone network (e.g., the Internet) through the different wired connection such as connection 156, 166, 176, 186 respectively and which wirelessly connects via an AP MLD to the non-AP MLD 116 using a wireless protocol such as IEEE 802.11 protocol. The distribution system 108 may transmit or receive data frames between the LAN or backbone network and one or both of the AP MLD 112, 114.

The non-AP MLD 116 includes two non-AP STAs 134, 136 which are implemented in hardware (e.g., circuits), software, firmware, or a combination thereof. The STAs 134, 136 may be fully or partially implemented as an IC device. In some embodiments, the STAs 134, 136 are part of the non-AP MLD 116, such that the non-AP MLD 116 may be a communications device that wirelessly connects to one or more AP MLD 112, 114. For example, the non-AP MLD 116 may be implemented in a laptop, a desktop personal computer (PC), a mobile phone, or other communications device that supports at least one WLAN communications protocol. In some embodiments, the non-AP MLD 116 implements MAC functionality which is divided between an MLD level common MAC functionality and the non-AP STAs 134 and 136 implement lower layer MAC data functionality. In some embodiments, each STA includes at least one antenna, at least one transceiver operably connected to the at least one antenna, and at least one controller connected to the corresponding transceiver. In some embodiments, an STA affiliated with a non-AP MLD includes multiple RF chains and the at least one transceiver in a PHY circuit of the STA. The at least one controller may be configured to control the at least one transceiver to transmit and receive frames. In some embodiments, the at least one controller may be implemented within a processor, such as a microcontroller, a host processor, a host, a DSP, or a CPU. The STAs may operate in one of a 5 GHz or 6 GHz band.

The seamless mobile domain 110 with AP MLDs 112, 114 positioned at different physical locations of the multi-link communications system 100 facilitates seamless roaming by a non-AP MLD 116 within an area covered by the seamless mobile domain 110. Because the area covered is large, chance of the non-AP MLD 116 transitioning from an AP MLD of one seamless mobile domain to an AP MLD of another seamless mobile domain is reduced. The non-AP MLD 116 sets up the association with the seamless mobile domain 110 through the links of one AP MLD affiliated with the seamless mobile domain 110. The links may be wireless connections between components of the multi-link communications system 100. In one or more embodiments, the non-AP MLD 116 may set up an association with seamless mobile domain 110 through links 118, 120 of an AP MLD 112 affiliated with a seamless mobile domain 110 and referred to as the serving AP MLD 112 at time t₀. The links facilitate uplink and downlink communication between the AP MLD 112 and the non-AP MLD 116 and each link defines a connection between an AP MLD and non-AP MLD. At some later time t₁, the non-AP MLD 116 seamlessly roams to another AP MLD, identified as a target AP MLD. The non-AP MLD 116 terminates the links 118, 120 with the serving AP MLD 112 and establishes links 122, 124 with target AP MLD 114 and DS mapping to the target AP MLD 114 to perform the seamless roaming to the target AP MLD 114. The non-AP MLD 116 roams from the serving AP MLD 112 to the target AP MLD 114 without disassociation and reassociation with the seamless mobile domain 110 and a state 4 operation is maintained (class 3 frame exchanges such as data frames, management frames, and control frames are continued without reassociation).

Embodiments disclosed herein are directed to seamless roaming in the seamless mobile domain 110 by providing information of one or more candidate target AP MLDs to which the non-AP MLD 116 is able to roam. An AP MLD such as the serving AP MLD 112 may provide the information of the SMD that it belongs to, e.g., the SMD identifier and SMD roaming characteristics. An AP MLD such as the serving AP MLD 112 may provide the information of one or more candidate target AP MLDs (in the same SMD as it) which the non-AP MLD may seamlessly roam to. For example, the information may be for candidate target AP MLD 112, 114, 150 but not AP MLD 152 which is not in a communication range with the non-AP MLD 116 in the SMD 110. The information of the candidate target AP MLDs may include the indication of the AP MLD being in the same SMD as the reporting AP MLD 112, the SMD identifier that the AP MLD belonging to, an AP MLD identifier, or a target beacon transmission time (TBTT) offset etc. as defined by the TBTT Information field in a reduced neighbor report (RNR) element. The serving AP MLD may provide the candidate target AP MLD information without receiving a soliciting request or after receiving the request. The non-AP MLD may request the recommendation or the information of the candidate target AP MLDs. In some embodiments, the non-AP MLD 116 provides its service requirements and based on the service requirements the serving AP MLD provides the information of candidate target AP MLDs. Based on the information of candidate target AP MLDs, the non-AP MLD 116 then selects the target AP MLD to roam to and sends a frame to the serving AP MLD 110 to transfer a frame exchange context of the non-AP AP MLD 116 from the serving AP MLD 110 to the target AP MLD, establish links with the target AP MLD and delete any link to the serving AP MLD to complete the seamless roaming to the target AP MLD. The frame exchange context may define a context (e.g., SN, PN, replay counter, BA agreement parameters) associated with uplink (UL) frame transmissions from the non-AP MLD 116 to an AP MLD and downlink (DL) frame transmissions from the AP MLD to the non-AP MLD 116). In some embodiments, the action frames related to seamless roaming are sent to the target AP MLD directly to establish links when the serving AP MLD is not reachable. Additionally, the non-AP MLD 116 reserves a resource with the target AP MLD during the roaming preparing stage (link establishment and a DS mapping change being performed) or during the roaming executing stage (finishing the DL frame exchange with the serving AP MLD if required etc.). The DS mapping change is a process by which the distribution system 108 is updated to transmit downlink (DL) MAC service data unit (M SDU) addressed to the non-AP MLD 116 to the target AP MLD and receive uplink (UL) MSDUs of the non-AP MLD 116 from by the target AP MLD.

In one or more embodiments, the SMD 110 has a unique identifier that may be an address such as a MAC address be carried in an SMD element transmitted by an AP MLD such as SMD element 160. The SMD element 160 in an example may be a data structure or frame for identifying the SMD. In some embodiments, the association, authentication, EAPOL (Extensible Authentication Protocol over LAN) key handshake between an AP MLD and non-AP MLD 116 are done by using/verifying the SMD identifier (media access control (MAC) address) of the seamless mobile domain (authenticator's MAC address is seamless mobile domain's address) that the AP MLD belongs to. In some embodiments, the association, authentication, pairwise master key (PMK), pairwise transient key (PTK) negotiation/derivation between endpoints are done through the MAC address of the SMD or SMD ID that serving/target AP MLD belongs to. In some embodiments, the association, authentication, pairwise master key (PMK), and pairwise transient key (PTK) negotiation/derivation between endpoints are done through an AP MLD MAC address of the serving AP MLD or the target AP MLD 114 when doing seamless roaming in the SMD with which the non-AP MLD 116 is trying to exchange data with. In some embodiments, once a non-AP MLD 116 roamed to the target AP MLD 114, the PTK, PMK may need to be negotiated with the target AP MLD 114. Further, if a key renewal is needed during the seamless roaming procedure, the target AP MLD's MAC address is used for key renewal.

In one or more embodiments, an AP MLD may indicate the identifier (e.g., MAC address) of an SMD (the identifier of SMD that the AP MLD belongs to and the group of other AP MLDs belong to where the non-AP MLD 116 may roam to the other AP MLD(s) of the SMD) in a newly defined element (SMD element) 160 carried in a Beacon, Association Request/Response with an AP MLD in the SMD, Authentication Request/Response with an AP MLD in the SMD, Extensible Authentication Protocol over LAN (EAPOL) Key, resassociation request/response or probe response. Besides the seamless mobile domain identifier (MAC address), the element may carry information of the candidate target AP MLDs that a non-AP MLD can seamlessly roam to, e.g. the AP MLD ID space to identify the candidate target AP MLDs, whether the simultaneous downlink frame exchanges with the two AP MLDs is allowed, whether data forwarding to target AP MLD is supported.

In one or more embodiments, the identifier of the SMD 110 is verified during an Authentication and EAPOL key negotiation. The SMD identifier is also used as the authenticator MAC address to create a pairwise transient key (PTK) of a ultra-high reliability (UHR) associated non-AP MLD that enables the seamless roaming. In some embodiments, the MAC address of the SMD as the identifier of a group of AP MLDs is used to replace the BSSID in the MAC header of unicast quality of service (QOS) data frames for the encryption and decryption of the unicast QoS Data frames. In some embodiments, the serving AP MLD's MAC Address is used to replace the BSSID in the MAC header of the unicast QoS Data frames for the encryption/decryption of the unicast QoS Data frames.

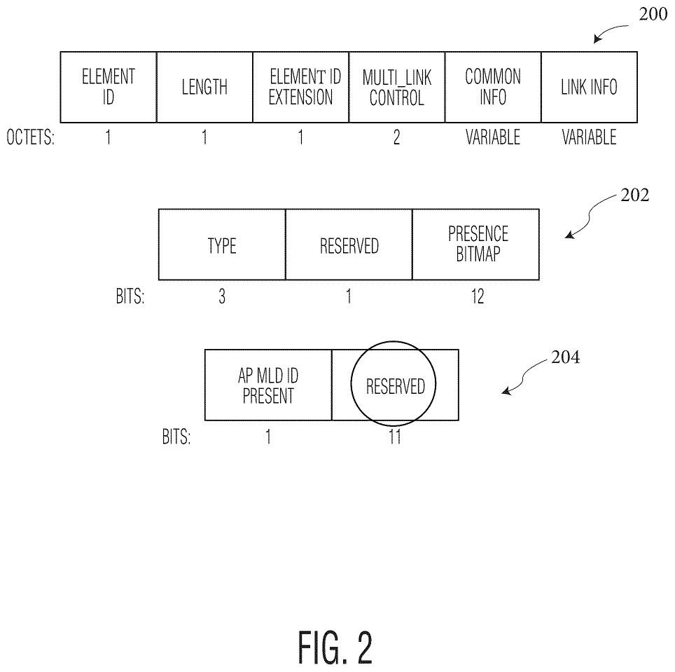

FIG. 2 illustrates an example basic multi-link element to carry information of candidate AP MLDs in accordance with one or more embodiments. The basic multi-link element 200 which indicates common information of an AP MLD is carried in a beacon or management frame such as a probe frame and indicates whether the AP MLD belongs to a SMD, i.e. whether the non-AP MLD 116 may roam to an AP MLD belonging to the group of AP MLDs that the serving AP MLD belongs to. The basic multi-link element 200 may have a Multi-Link Control field with a plurality of fields shown as Multi-Link Control field 202. The Multi-Link Control field 202 may include a Presence Bitmap field with a plurality of fields shown as Presence Bitmap field 204. The AP MLD may repurpose one current reserved bit in a Presence Bitmap field 204 to indicate whether the AP MLD belongs to a SMD, i.e. whether the non-AP MLD may roam to the AP MLD seamlessly. In one or more embodiments, if an AP MLD supports seamless roaming and a candidate target AP MLD can be seamlessly roamed to from the reporting AP MLD, a one-bit indication may announce that the seamless roaming can be done between the AP MLD and the candidate target AP MLD. The reporting AP MLD may be an AP MLD in the SMD 110 such as the serving AP MLD with which the non-AP MLD is associated.

An AP MLD identifier (ID) may be used to identify the candidate target AP MLD that is in a same SMD 110 as the reporting AP MLD. The reporting AP MLD is the AP MLD that the reporting AP (the AP transmits the Beacon or Probe Response, or the AP that is in the same multiple BSSID AP set as the transmitted BSSID AP transmitting the Beacon or Probe Response) is affiliated with. The AP MLD ID may be included in the information of a candidate target AP MLD and be an identification in an AP MLD ID space. The AP MLD ID space for candidate target AP MLDs indicates the AP MLD ID values can be allocated to a candidate target AP MLDs that a non-AP MLD associated with the reporting AP MLD can seamlessly roam to from the reporting AP MLD in a same SMD. The AP MLD announces the minimal candidate target AP MLD ID value. The candidate target AP MLD ID space of the AP MLD is defined by the announced minimal candidate target AP MLD ID value to 254.

In some embodiments, the values of a candidate target AP MLD ID space are not used for identifying the AP MLDs in the same AP device and are used to identify the candidate target AP MLDs in a different AP device. The AP MLD ID spaces for the candidate roaming AP MLDs announced in all the links of an AP device are the same. A candidate target AP MLD also has the same AP MLD ID in all the links of an AP device. Further, values of candidate target AP MLD ID space are not used by all the AP MLDs among all the links in the AP device. The virtual APs of a link of an AP device may supports multiple BSSID feature where the virtual APs of the link belongs to a multiple BSSID AP set, and each AP of the multiple BSSID AP set may be affiliated with an AP MLD in the AP device. Each AP MLD with which an AP of the multiple BSSID AP set is affiliated with has its AP MLD ID value no more than 2ⁿ−1 where n is defined by the MaxBSSID Indicator field of the Multiple BSSID AP set. For the link, the AP MLD ID values from 2ⁿ to 254 are not allocated to the AP MLDs of the AP device. For example, in one AP device with three links. Link1 has 4 virtual APs belong to a multiple BSSID AP set with its MaxBSSID Indicator field equal to 2 where each virtual AP is affiliated with an AP MLD in the AP device. In link1, AP MLD ID values 0 to 3 are used to identify the AP MLDs in the AP device. Link2 has 32 virtual APs belong to a multiple BSSID AP set with its MaxBSSID Indicator field equal to 5 where each virtual AP is affiliated with an AP MLD. In link2, AP MLD ID values 0 to 31 are used to identify the AP MLDs in the AP device. The AP MLD ID values from 32 to 254 are not allocated to the AP MLDs in the AP device. In link3, AP MLD ID values 0 to 63 are used to identify the AP MLDs in the AP device. The AP MLD ID values from 64 to 254 are not allocated to the AP MLDs in the AP device. In such AP device, the values of candidate target AP MLD ID space are AP MLD ID more than 64 and less than 254, e.g. 64 to 254, 128 to 254.

In some embodiments, the values of a candidate target AP MLD ID space are not used for identifying the AP MLDs among the links of the reporting AP MLD and are used to identify the candidate target AP MLDs in a different AP device. The AP MLD ID spaces for the candidate roaming AP MLDs announced in all the links of an reporting AP MLD are the same. A candidate target AP MLD also has the same AP MLD ID in all the links of a reporting AP MLD. The reporting AP MLD is the AP MLD that the AP transmitting the Beacon is affiliated with. Further, the values of candidate target AP MLD ID space are not used by the AP MLD IDs of all the AP MLDs among all the links in the reporting AP MLD. For example, in one AP device with three links. Link1 has 4 virtual APs belong to a multiple BSSID AP set with its MaxBSSID Indicator field equal to 2 where each virtual AP is affiliated with an AP MLD in the AP device. In link1, AP MLD ID values 0 to 3 are used to identify the AP MLDs in the AP device. Link2 has 32 virtual APs belong to a multiple BSSID AP set with its MaxBSSID Indicator field equal to 5 where each virtual AP is affiliated with an AP MLD. In link2, AP MLD ID values 0 to 31 are used to identify the AP MLDs in the AP device. The AP MLD ID values from 32 to 254 are not allocated to the AP MLDs in the AP device. In link3, AP MLD ID values 0 to 63 are used to identify the AP MLDs in the AP device. For an AP MLD with link1 and link 2 as the reporting AP MLD, the values of candidate target AP MLD ID space are AP MLD ID more than 32 and less than 254, e.g. 32 to 254, or 128 to 254. For an AP MLD with link1 and link3 as the reporting AP MLD, the values of candidate target AP MLD ID space are AP MLD ID more than 64 and less than 254, e.g. 64 to 254, or 128 to 254. The AP MLD ID space for identifying seamless roaming is announced by an AP MLD in the management frame, e.g. beacon. In one or more embodiments, all the links of the reporting AP MLD report the same AP MLD ID for a candidate target AP MLD belonging to the same SMD 110 as the reporting AP MLD or the different AP MLDs of a SMD 110 may report the different AP MLD IDs for an AP MLD in the same SMD. In one or more embodiments, the APs in all the links of the AP device report the same AP MLD ID for a candidate target AP MLD belonging to the same SMD 110. In one or more embodiments, the different AP MLDs of a SMD 110 report the different AP MLD IDs for an AP MLD in the same SMD, i.e. the different AP MLDs of a SMD 110 report independently the AP MLD IDs for an AP MLD in the same SMD.

In one or more embodiments, before the association with an AP MLD, a non-AP MLD can collect the information of the candidate target AP MLDs that an AP MLD knows. In one or more embodiments, after the association with an AP MLD, a non-AP MLD can collect the information of the candidate target AP MLDs that are in the same seamless roaming domain as the associated AP MLD only. Various signaling may be used to identify information of candidate target AP MLDs to which the non-AP MLD is able to seamlessly roam in accordance with one or more embodiments. The information may be for one or more of the candidate target AP MLDs in the SMD to which the non-AP MLD may seamlessly roam to.

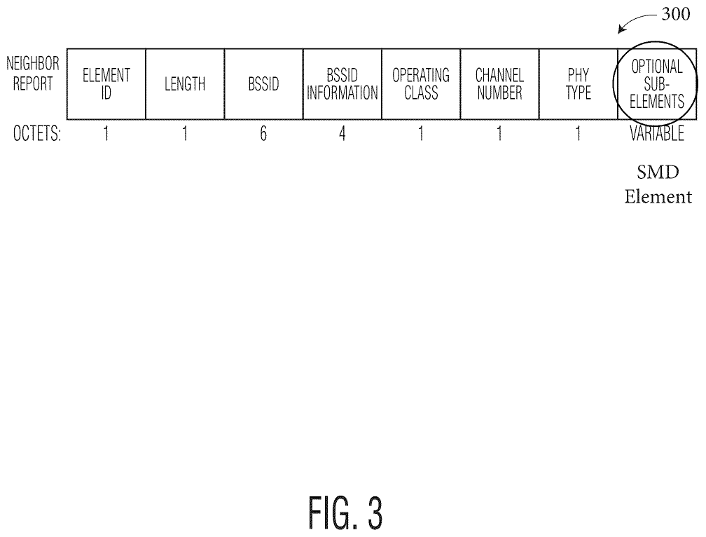

FIG. 3 illustrates an example neighbor report element 300 to carry the information of the candidate target AP MLDs in accordance with one or more embodiments. The neighbor report element may be provided in an AP's neighbor report response to a neighbor report request transmitted by the non-AP MLD 116 to acquire information of the candidate target AP MLDs. The neighbor report element may be provided in AP's BTM Request for non-AP MLD 116 to acquire information of the recommended candidate target AP MLDs. In one or more embodiments, the neighbor report element 300 may indicate information of candidate target AP MLDs that belong to same SMD as the reporting AP MLD, the target AP MLD ID, and the SMD ID being carried in SMD element as the subelement of Neighbor Report element. The neighbor report element 300 may indicate the information related to seamless roaming (SMD element) in its optional sub-elements field. The neighbor report element 300 can be used under Multiple BSSID support or under no multiple BSSID support by an AP. A sub-element may be the multi-link element 200 with a bit in the common info field to indicate whether the AP MLD belong to a seamless roaming domain. Further, a new sub-element may be SMD element with the roaming domain identifier indicating the SMD that the AP MLD is in and the other seamless roaming related information. Resources supported by the candidate target AP MLD such as SCS agreement support, BA agreement support, target wakeup time (TWT) agreement support may be indicated as a sub-element in the neighbor report element 300 as information of the candidate target AP MLD. SCS agreement support indicates whether the candidate target AP MLD satisfies the SCS agreement of the non-AP MLD. BA agreement support indicates whether the candidate target AP MLD satisfies the downlink/uplink (DL/UL) BA agreements with the non-AP MLD. TWT agreement support indicates whether the candidate target AP MLD satisfies the TWT agreements of the non-AP MLD.

In one or more embodiments, a ‘Same SMD’ indication may be added to the BSSID Information in the neighbor report element, to signal whether the reported neighboring AP is part of the same SMD as the reporting AP. In one or more embodiments, the SMD element may be a subelement in the Optional Subelements of the Neighbor Report element, when reported neighboring AP is not part of the same SMD.

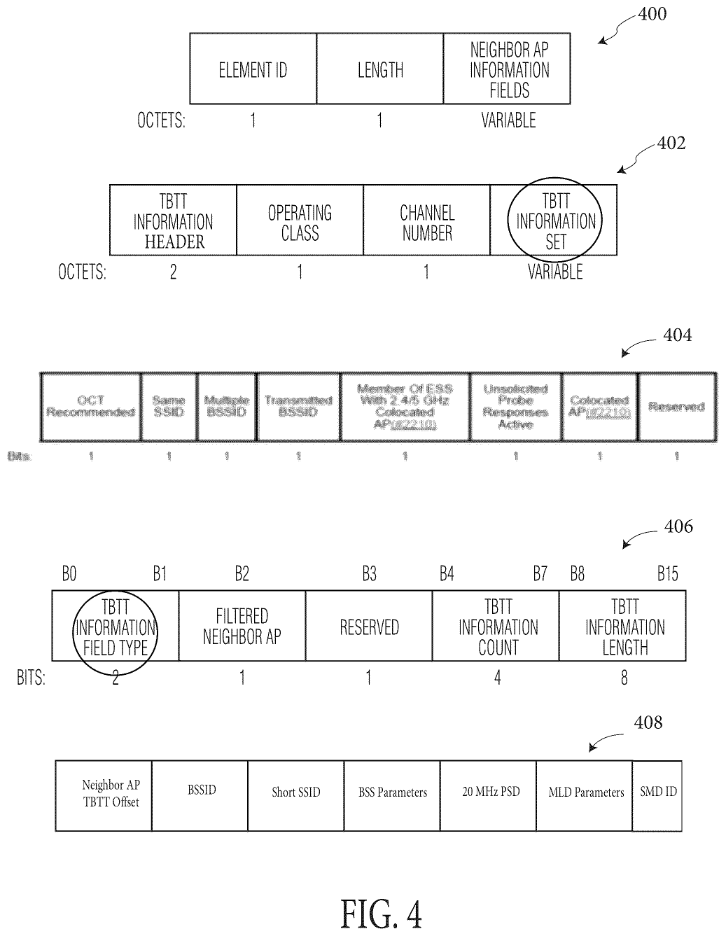

FIG. 4 illustrates an example updated reduced neighbor report (RNR) element 400 to carry the information of the candidate target AP MLDs in accordance with one or more embodiments. The RNR element 400 may allow a non-AP MLD to discover 6 GHZ APS through 2.4/5 GHz link, the AP MLD information that an AP belongs to. The updated RNR 400 can be used to find the candidate target AP MLD information. The updated RNR element 400 indicates APs of neighboring AP MLDs in the wireless network which may be candidate target AP MLDs that the non-AP MLD is able to roam to, i.e. whether the AP is affiliated with an AP MLD that is in the same SMD as the reporting AP MLD. In one or more embodiments, the RNR element 400 transmitted in a beacon or probe response is used to identify the information of the candidate target AP MLDs and the APs affiliated with the candidate target AP MLDs. In one or more embodiments, certain AP MLDs in the seamless mobile domain 110 are not indicated in the RNR element. If an AP MLD cannot be roamed from the reporting AP MLD through seamless roaming procedure or disallowed to be roamed to, the APs affiliated with the AP MLD are not carried in the RNR element.

The RNR element 400 has neighbor AP information fields with a neighbor AP information field. An example of the neighbor information field is shown as neighbor information field 402 having a target beacon transmission time (TBTT) Information Set is carried in the neighbor AP information field of the RNR element 400 to indicate information about a target beacon transmission time. In one or more embodiments, the TBTT Information set includes a Neighbor AP TBTT offset, basic service set (BSS) identifier (BSSID), BSS Parameter, Tx power restriction (20 Hz power spectral density (PSD) or Tx power restriction in dbm), a link ID, a reporting AP MLD ID (or seamless mobile domain ID) and a candidate target AP MLD load information (e.g., indication of amount of data traffic handled by the AP MLD). The BSS parameters is carried in a BSS parameters field 404. Further, the neighbor information field 402 may also have an TBTT Information header 406 with an TBTT Information Field type.

In one or more embodiments, a new TBTT Information Field Type in a TBTT Information field 408 of the TBTT Information Set transmitted in a beacon carries the information of candidate target AP MLDs and announces an AP affiliated with a candidate target AP MLD in the same seamless mobile domain 110 that a non-AP MLD 116 associated with a serving AP MLD can roam to through seamless roaming. The TBTT information field 408 includes the AP MLD ID of a candidate target AP MLD.

Further, each TBTT Information field 408 may have an AP MLD ID field of the AP MLD which reports the RNR element. The AP MLD ID may be selected from a respective AP MLD ID space to identify the candidate target AP MLD.

In one or more embodiments, a TBTT Information Field Type which is a field within the beacon frame that defines structure of the TBTT information field 408 may be reused in the RNR element. The field type 0 may be reused. The TBTT information field 408 for TBTT Information Field Type (Type 0) includes an AP MLD ID which is an identifier of the candidate target AP MLD. One reserved bit of the BSS parameters field 404 may be repurposed to indicate that the AP MLD belongs to the same SMD as the reporting AP MLD. In some embodiments, a 1-octet SMD ID field (e.g., SMD element) can be added to the end of TBTT Info field 408 such that the TBTT Info field has the length of 17 octets. In some embodiments, the value in 1-octet SMD ID announced for a link (link 1) of a candidate target AP MLD is same as a BSSID index of the AP of the link (link1) if the AP's affiliated AP MLD is in the same SMD as the candidate target AP MLD. The following is an example, the AP with multiple BSSID index 2 (AP12) in link1 is affiliated with an AP MLD (AP MLD1) where the AP MLD is in SMD with SMD identifier SMD ID1. AP MLD 1 has a candidate target AP MLD 2. When AP 12 with transmitted BSSID of link1 transmits the Beacon with RNR element carrying the target AP MLD information, the information of the candidate target AP MLD 2 has SMD ID 2. In some embodiments, the 1-octet SMD ID and the BSS Parameters Change Count field may be combined to carry a MD ID (mobile domain ID).

The non-AP MLD 116 may identify a candidate target AP MLD to which to roam based on whether a candidate target AP MLDs to which the non-AP MLD is able to roam satisfies a service requirement. The decision may be based on service information of the candidate target AP MLD received from an AP MLD. In one or more embodiments, the non-AP MLD may also indicate a service requirement that is different from the service provided by the serving AP MLD.

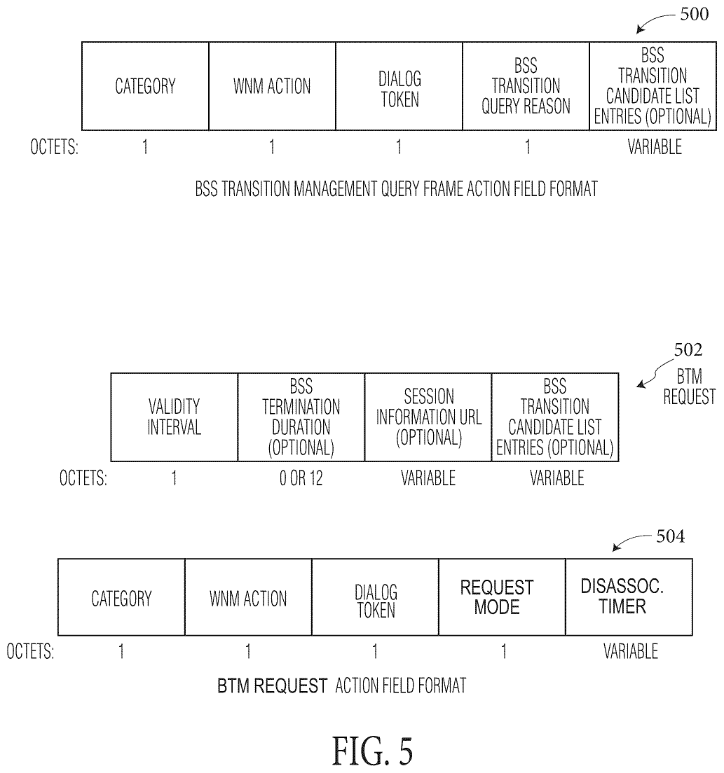

FIG. 5 illustrates example signaling relating to selection of a target AP MLD to which the non-AP MLD seamlessly roams in accordance with one or more embodiments.

In one or more embodiments, a basic service set (BSS) transition message (BTM) query 500 taking the form of an action frame sent by a non-AP MLD 116 and having action fields may carry an indication of candidate target AP MLD which it has detected in the BSS Transition candidate list field and a requested service requirement through the BSS Transition Query Reason field. A new reason value in the BSS transition query reason field is defined for such purpose. A non-AP MLD 116 may use the BTM Query 500 to announce the service requirement of the non-AP MLD that is different from the current service provided by a serving AP MLD. Another variant is that all the service requirements are announced explicitly even if the service requirements are same as the service requirements as the serving AP MLD. The service requirements may include QoS characteristic of traffic streams defined through SCS, agreement of R-TWT and the other TWT, activation of EPCS, and the other agreements. The BTM Query 500 may also indicate whether the non-AP MLD accepts the candidate target AP MLDs that cannot satisfy the announced service requirement.

In one or more embodiments, a BTM procedure may be used to recommend the candidate target AP MLDs (indicate the information of the candidate target AP MLDs). The BTM procedure includes sending a BTM request 502 to the non-AP MLD 116 and receiving a BTM response from the non-AP MLD. In one or more embodiments, the BTM request 502 may be transmitted after receiving the BTM query or without receiving the BTM query. In one or more embodiments, the AP MLD may send a basic service set (BSS) transition (BTM) request 502 to indicate the information of candidate target AP MLDs for the non-AP MLD 116. The candidate target AP MLDs identified by the information may be based on how close the service information of the candidates match with the service requirements of the non-AP MLD. The BTM request 502 has a BSS Transition Candidate List Entry with a neighbor report element 300. In one or more embodiments, a neighbor report element 300 may be used to carry the information of the candidate target AP MLD in the BTM request 502. The AP MLD may indicate whether a recommended candidate target AP MLD satisfies the service requirement of the non-AP MLD. The indication may be a BSS Transition Candidate List Entry of the BTM request 502 that describes a candidate target AP MLD, e.g. in the BSSID Information subfield or an Optional sub-element of the neighbor report element 300 and SCS, R-TWT, EPCS etc. of the candidate target AP MLDs may be separately indicated in the neighbor report element 300 or in a BTM Request Action frame 504. If the non-AP MLD didn't send BTM Query 500, the current service provided by the serving AP MLD is used as the reference.

In one or more embodiments, the non-AP MLD 116 may provide a BTM Response (not shown) to the BTM request 502 to indicate the candidate target AP MLDs that it selects for seamless roaming. A non-AP MLD can select the target AP MLD based on the roaming AP MLD's indication about whether an AP MLD can satisfy the non-AP MLD's service requirement and the other consideration, e.g. RSSI to an AP MLD, QoS characteristic of traffic streams defined through SCS, agreement of restricted target wakeup time (R-TWT) and the other TWT, activation of EPCS, and the other agreements. The service information of the AP MLD may be provided in many ways.

The information of candidate AP MLDs may be obtained in many other ways. Examples include use of Action frames and probe requests/responses to obtain the information. The information may include the identifier of the candidate AP MLD and in some examples additional information such as resources of the candidate AP MLDs or information is provided in the RNR element or neighbor report element.

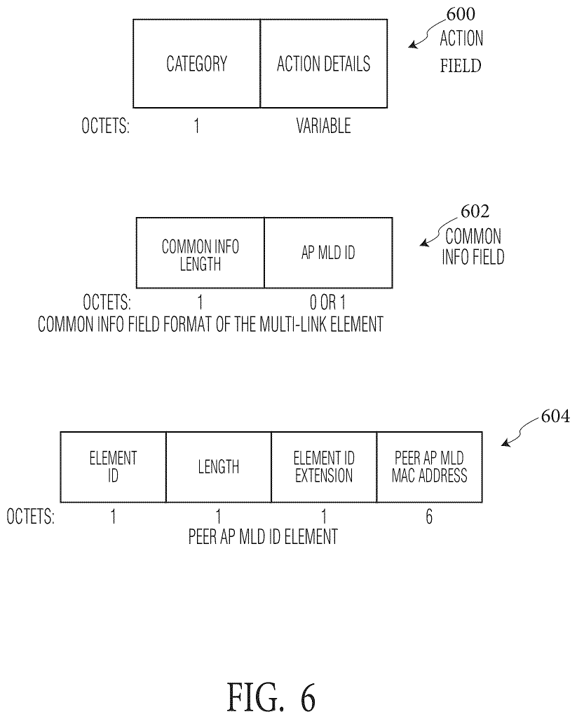

FIG. 6 illustrates additional example signaling for obtaining the information of the candidate AP MLDs in accordance with one or more embodiments.

The non-AP MLD may use new action frames 600 with action fields to solicit information of candidate target AP MLDs that are detected. The new action frames 600 include a candidate target AP MLD (CTAM) request and candidate target AP MLD response. The CTAM request frame is used to solicit the information of candidate target AP MLDs. The CTAM response carries a RNR element 400 that includes the information of the requested candidate target AP MLDs or a neighbor report element 300 that includes the information of the candidate target AP MLD. Based on the action frame 600, a non-AP MLD without association as the AP's AP MLD can also collect information of the candidate target AP MLDs that are in the same seamless mobile domains as the AP's AP MLD and the AP MLDs whose affiliated APs are in the same multiple BSSID AP set as the AP in the link.

In one or more embodiments, a non-AP MLD may acquire the information of a candidate target AP MLD, e.g. using a probe request addressed to the serving AP MLD to solicit full information of the candidate target AP MLD. The probe request has a multi-link element 200 with a common info field 602 to indicate the information of the candidate target AP MLD including the AP MLD ID of the candidate target AP MLDs. The probe request is used to obtain the information of a candidate target AP MLD when the full information of the candidate target AP MLD is not received.

In one or more embodiments, the probe request may indicate solicitation by the non-AP MLD 116 of the information of a candidate target AP MLD. The AP MLD ID in the multi-link element 200 of the probe request indicates for which AP MLD the information is solicited. The element may indicate that the probe request solicits the information of the candidate target AP MLDs. In one or more embodiments, the probe request has a wildcard SSID or wildcard BSSID in address 3 to solicit the information of a candidate target AP MLD. The probe response carries the information of the requested candidate target AP MLDs in RNR element 400 besides the other information in probe response frame. In some embodiments, the probe response only carries the information of the requested candidate target AP MLDs in the RNR element 400. The frame is carried in a ultra-high reliability (UHR) physical layer protocol data unit (PPDU).

In one or more embodiments, the probe request carries the identifier of the candidate target AP MLD, e.g., by using the Peer AP MLD ID element 604. The Peer AP MLD ID element 604 carries the identifier of the Peer AP MLD (e.g., candidate target AP MLD). In some embodiments, the AP MLD MAC address is used as the identifier in the Peer AP MLD MAC address. In some embodiments, the AP MLD ID is used as the identifier.

In one or more embodiments, a non-AP MLD may start the seamless roaming with the target AP MLD directly since the link with the current serving AP MLD is not available, e.g. using roaming preparing/executing request (Link Reconfiguration request) addressed to the target AP MLD. In this embodiment, the roaming executing request may also carry the identifier of the current serving AP MLD, e.g. by using the Peer AP MLD ID element 604.

In one or more embodiments, a resource reservation is done during a roaming preparing request/response (Link Reconfiguration Request/Response) or roaming executing Request/Response for DS mapping updating, frame exchange context transfer procedure between the non-AP MLD and target AP MLD. The resource reservation may indicate resources needed by the non-AP MLD to complete the seamless roaming. The resources may include a Link mapping, block acknowledgement (BA) agreement if new agreement is required, M SCS agreement updating or establishment, SCS agreement updating or establishment, TID-to-link mapping announcement if the target AP MLD doesn't use the default TID-to-Link mapping, and target wakeup time (TWT) agreement establishment. In some embodiments, by default an SCS agreement is transferred from the current AP MLD to the new AP MLD. In some embodiments, unless the SCS new agreement is required by the non-AP MLD in roaming process, the SCS agreement establishment is not needed.

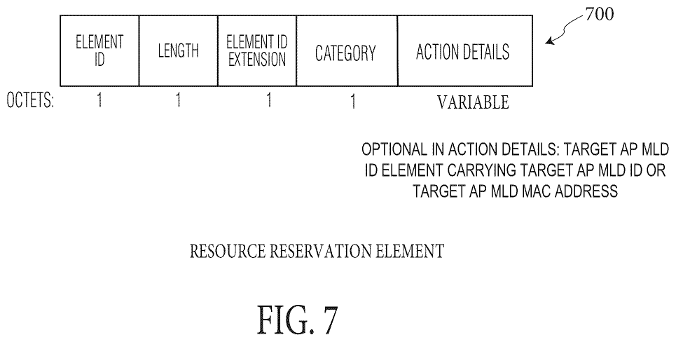

FIG. 7 illustrates an example resource reservation element for a non-AP MLD to reserve a resource of a target AP MLD in accordance with one or more embodiments. One or multiple resource reservation elements are defined for encapsulating the resource request/response in a roaming preparing request/response (Link Reconfiguration Request/Response) or roaming executing Request/Response between the non-AP MLD and selected target AP MLD through the serving AP MLD. In one or more embodiments, the link for collecting candidate target AP MLD information is used for roaming execution or the link for collecting candidate target AP MLD information and the link for roaming execution can be different. After identifying the candidate target AP MLD, a roaming preparing request/response (Link Reconfiguration Request/Response) or roaming executing Request/Response may be used for establishing a link with the target AP MLD that the non-AP MLD selects to roam to. A resource reservation element 700 may have action fields to carry an action field of the request/response and a newly defined element that carries the target AP MLD ID or target AP MLD MAC address. In some embodiments, the newly defined element is a Target AP MLD ID element which is not sub-element of the Resource Reservation element 700. Note the reason for this option is that the target AP MLD is already indicated by the other element of roaming preparing request, roaming executing request frame. In some embodiments, the Target AP MLD ID element is the subelement of the Resource Reservation element 700 (part of Action Detail).

In some embodiments, the resource reservation may be done through separate resource negotiation with the target AP MLD before finishing the roaming (DS mapping updating) instead of doing the resource reservation negotiation with the target AP MLD through roaming preparing/executing Request/Response. In one or more embodiments, the related request/response frame is exchanged with the target AP MLD carried through the serving AP MLD or with the target AP MLD directly. The request/response frame carries the target AP MLD ID or target AP MLD MAC address in target AP MLD ID element. In one or more embodiments, the request/response frame for MLD level resource reservation at the target AP MLD carries the newly defined element. For example, the TID-to-Link Mapping Request, Response frame may carry the new element that identifies the target AP MLD. As another example, a request/response frame for link level resource reservation at the target AP MLD indicates the newly defined element and the applied link (e.g. MLO Link Info element). For example, the TWT Setup frame carries the new element that identifies the target AP MLD, the TWT element with Link ID Bitmap field.

A non-AP MLD may seamlessly roam with the target AP MLD directly, e.g. when the serving AP MLD is not reachable anymore. The roaming procedure needs to be protected, e.g., an Action frame for roaming from the serving AP MLD to the target AP MLD is protected. In one or more embodiments, the non-AP MLD performs a seamless roaming without negotiated new PTK with the target AP MLD. The Action frame for roaming that is addressed to the target AP MLD is encrypted by using a PTK, pseudo number (PN) of the serving AP MLD and the Action frame addressed to the non-AP MLD directly from the target AP MLD is encrypted using the PTK, PN of the serving AP MLD. The Action frame carries the high efficiency (HE) Control field to identify the serving AP MLD. The HE Control field carries the AP MLD ID and Link ID of the serving AP MLD. The Link ID indicates the link where the AP MLD ID is applied. If all the AP MLD IDs that can be seamlessly roamed to from one AP MLD have the same values in all the links of the AP MLD, then the Link ID is not needed for all of the AP MLDs.

In one or more embodiments, the non-AP MLD performs a seamless roaming with a negotiated new PTK with the target AP MLD. During the roaming operation, the non-AP MLD may negotiate the new PTK with the target AP MLD. A key negotiation procedure before association can be used. The Peer AP MLD ID element 612 (with MLD MAC address of the serving AP MLD or AP MLD ID of the serving AP MLD announced by the target AP MLD) is carried in the Action frame to identify the serving AP MLD.

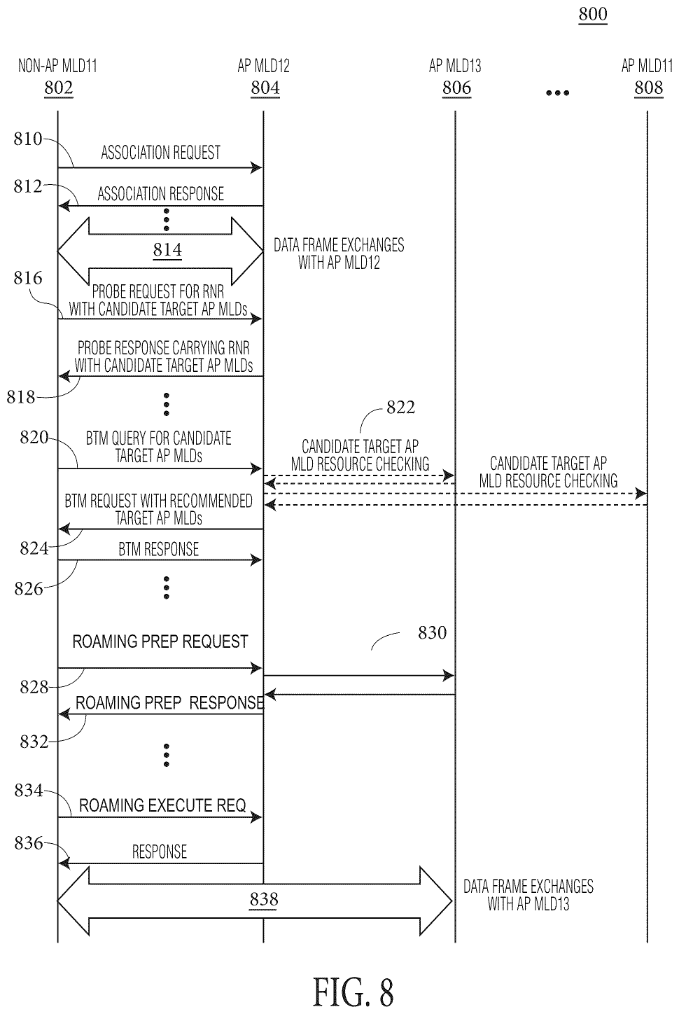

FIG. 8 illustrates example communication 800 between the non-AP MLD and a plurality of AP MLD to perform a seamless roaming process in an SMD 110 in accordance with one or more embodiments. A non-AP MLD 802 may be roaming in an SMD includes AP MLD 804, 806, 808.

The seamless roaming may begin at 810 with the non-AP MLD 802 sending an association request to the AP MLD 804 being part of a SMD to associate with the AP MLD 804. At 812, the AP MLD 804 may send an association response which results in ability to exchange data between the non-AP MLD 802 and serving AP MLD 804 at 814. Additionally, an Association Response, Authentication Response, or Extensible Authentication Protocol over LAN (EAPOL) Key frame may be exchanged. The non-AP MLD 802 may seek to perform a seamless roaming in the SMD. In an example, the non-AP MLD 802 may send a probe request for RNR element with information of candidate target AP MLD to roam to at 816 and receive at 818 a probe response with the RNR element and information of candidate target AP MLDs. The non-AP MLD 802 may further announce its service requirements for the AP MLD to further identify candidate target AP MLDs. At 820, the non-AP MLD 802 may send a BTM Query for candidate target AP MLDs. The BTM Query may cause the AP MLD 804 to check resources/service information of the AP MLD 806, 808 and provide optional indications of the resources/service information of the AP MLDs 806, 808 back to the AP MLD 804 at 822. At 824, the AP MLD 804 may send a BTM request to the non-AP MLD 802 identifying information of candidate target AP MLDs optionally based on service requirements of the non-AP MLD 802 and at 826 the non-AP MLD 802 will sent a response to identify the selected target AP MLD to seamlessly roam to. If AP MLD 806 is selected as the target AP MLD, then the non-AP MLD 802 may send a roaming preparing request (e.g., Link Reconfiguration Request with indicated extensions) to the AP MLD 806 currently serving the non-AP MLD 802 at 828 and the serving AP MLD 804 may trigger the target AP MLD's configuring links and DS mapping change with the non-AP 802 by messaging at 830 and at 832 send a roaming preparing response (e.g., Link Reconfiguration Response with indicated extensions) to the non-AP MLD 804 to indicate the link is established with the target AP MLD 806. The roaming preparing request 828 and Response 832 (Link Reconfiguration Request and Link Reconfiguration Response) carry the target AP MLD MAC address as the target AP MLD identifier in MLD Address field in Reconfiguration Multi-Link element and an MLD Address field in a Basic Multi-Link Element. At 834, the non-AP MLD 802 may signal the AP MLD 804 to do the roaming execution by using roaming executing request frame (e.g., Link Reconfiguration Request with extensions) to the AP MLD 806 and at 836 the non-AP MLD 802 may receive a response (e.g., Link Reconfiguration Response with indicated extensions). The non-AP MLD 802 may be able to exchange data with the target AP MLD 806 as a result of the smooth roaming at 838 and links to the serving AP MLD 806 may be terminated.

In one or more embodiments, the roaming preparing request and roaming executing request carries the information of the single target AP MLD only. In one or more embodiments, action frames and the request/responses as described herein may be control or management frames defined by IEEE 802.11 to support WiFi communications between the non-AP MLD and AP MLD. In one or more embodiments, an AP can transmit the BTM Request frame unsolicited or as a response to BTM Query from a non-AP MLD.

In one or more first embodiments, a method of seamless roaming in a seamless mobile domain of a wireless network is disclosed. The method includes: receiving from an access point multi-link device (AP MLD) in the wireless network information of one or more candidate target AP MLDs to seamlessly roam to, the information including a seamless roaming domain (SMD) element that identifies a respective seamless roaming domain of the one or more candidate target AP MLDs; selecting a target AP MLD from the one or more candidate AP MLDs based on the information; and roaming to the target AP MLD. In one or more embodiments, the information of the one or more candidate target AP MLDs is carried in a reduced neighbor report (RNR) element transmitted in a beacon or probe response frame. In one or more embodiments, the RNR element defines a target beacon transmission time (TBTT) Information Type 0 to signal that the RNR element indicates the one or more candidate target AP MLDs. In one or more embodiments, the SMD element is carried in an Association Response, Authentication Response, or Extensible Authentication Protocol over LAN (EAPOL) Key frame transmitted by an AP MLD of the SMD. In one or more embodiments, the SMD element includes an SMD identifier of the SMD which is an MAC address, the information of the target AP MLD including the SMD identifier. In one or more embodiments, the SMD identifier is used for identifying the SMD and the non-AP MLD associates with a serving AP MLD of the SMD based on the SMD identifier. In one or more embodiments, the SMD identifier is used for identifying the SMD, the non-AP MLD does authentication with a serving AP MLD of the SMD, and the SMD identifier is used as an authenticator MAC address for pairwise transient key (PTK) creation. In one or more embodiments, a Neighbor Report element carries the SMD element to identify an SMD to which a candidate target AP MLD belongs. In one or more embodiments, the Neighbor Report element carries the indication whether the candidate target AP MLD in the Neighbor Report element and a reporting AP MLD belongs to a same SMD. In one or more embodiments, the method further includes sending a roaming request to a single selected candidate target AP MLD to do roaming preparation. In one or more embodiments, the method further includes receiving a basic service set (BSS) transition message (BTM) request having a neighbor report element with service requirements of the one or more candidate target AP MLDs and sending a BTM response to indicate the candidate target AP MLDs that meet defined service requirements. In one or more embodiments, the one or more candidate target AP MLDs are identified by AP MLD identifiers in an AP MLD ID space not used by another AP device in the same AP device as a reporting AP MLD or by links of the reporting AP MLD in the AP device which is not one of the candidate target AP MLDs. In one or more embodiments, the method further includes transmitting a BTM query by a non-AP MLD having an indication that a query is for candidate target AP MLDs in a same SMD as a recipient AP MLD. In one or more embodiments, the method further includes the BTM query indicates service requirements of a non-AP MLD different from services provided by a serving AP MLD. In one or more embodiments, the method further includes establishing a resource reservation with the target AP MLD by a resource reservation element which includes an identification of the target AP MLD in an action details field of the resource reservation element. In one or more embodiments, a Link Reconfiguration Request and Response are used to establish the links with the target AP MLD. In one or more embodiments the Link Reconfiguration Request and Response are used as the roaming preparing request and roaming preparing response.

In one or more second embodiments, a non-AP MLD in a seamless mobile domain (SMD) of a wireless network is disclosed. The non-AP MLD is arranged to receive from an access point multi-link device (AP MLD) in the wireless network information of one or more candidate target AP MLDs to seamlessly roam to, the information including a seamless roaming domain (SMD) element that identifies a respective seamless roaming domain of the one or more candidate target AP MLDs; select a target AP MLD from the one or more candidate AP MLDs based on the information; and roam to the target AP MLD. In one or more embodiments, the SMD element is carried in an Association Response, Authentication Response, or Extensible Authentication Protocol over LAN (EAPOL) Key frame transmitted by a serving AP MLD of the SMD. In one or more embodiments, the SMD element includes an SMD identifier of the SMD which is an MAC address, the information of the target AP MLD including the SMD identifier. In one or more embodiments, a Neighbor Report element carries the SMD element to identify a SMD to which a candidate target AP MLD belongs. In one or more embodiments, the Neighbor Report element carries the indication whether the candidate target AP MLD in the Neighbor Report element and a reporting AP MLD belongs to a same SMD. In one or more embodiments, the one or more candidate target AP MLDs are identified by AP MLD identifiers in an AP MLD ID space not used by another AP device in the same AP device as a reporting AP MLD or by links of the reporting AP MLD in the AP device which is not one of the candidate target AP MLDs. In one or more embodiments, the non-AP MLD is further arranged to establish a resource reservation with the target AP MLD by a resource reservation element which includes an identification of the target AP MLD in an action details field of the resource reservation element. In one or more embodiments, a Link Reconfiguration Request and Response are used to establish the links with the target AP MLD.

The foregoing disclosure provides illustration and description but is not intended to be exhaustive or to limit the aspects to the precise form disclosed. Modifications and variations may be made in light of the above disclosure or may be acquired from practice of the aspects.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code it being understood that software and hardware can be designed to implement the systems and/or methods based, at least in part, on the description herein.

As used herein, the term “non-transitory machine-readable storage medium” will be understood to exclude a transitory propagation signal but to include all forms of volatile and non-volatile memory. When software is implemented on a processor, the combination of software and processor becomes a specific dedicated machine.

Because the data processing implementing the embodiments described herein is, for the most part, composed of electronic components and circuits known to those skilled in the art, circuit details will not be explained in any greater extent than that considered necessary as illustrated above, for the understanding and appreciation of the underlying concepts of the aspects described herein and in order not to obfuscate or distract from the teachings of the aspects described herein.

Unless stated otherwise, terms such as “first” and “second” are used to arbitrarily distinguish between the elements such terms describe. Thus, these terms are not necessarily intended to indicate temporal or other prioritization of such elements.

It should be appreciated by those skilled in the art that any block diagrams herein represent conceptual views of illustrative hardware embodying the principles of the aspects.

While each of the embodiments are described above in terms of their structural arrangements, it should be appreciated that the aspects also cover the associated methods of using the embodiments described above.

Unless otherwise indicated, all numbers expressing parameter values and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by embodiments of the present disclosure. As used herein, “about” may be understood by persons of ordinary skill in the art and can vary to some extent depending upon the context in which it is used. If there are uses of the term which are not clear to persons of ordinary skill in the art, given the context in which it is used, “about” may mean up to plus or minus 10% of the particular term.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method of seamless roaming in a seamless mobile domain of a wireless network, the method comprising:
receiving from an access point multi-link device (AP MLD) in the wireless network information of one or more candidate target AP MLDs to seamlessly roam to, the information including a seamless roaming domain (SMD) element that identifies a respective seamless roaming domain of the one or more candidate target AP MLDs;
selecting a target AP MLD from the one or more candidate AP MLDs based on the information; and
roaming to the target AP MLD.

2. The method of claim 1, wherein the information of the one or more candidate target AP MLDs is carried in a reduced neighbor report (RNR) element transmitted in a beacon or probe response frame.

3. The method of claim 2, wherein the RNR element defines a target beacon transmission time (TBTT) Information Type 0 to signal that the RNR element indicates the one or more candidate target AP MLDs.

4. The method of claim 1, wherein the SMD element is carried in an Association Response, Authentication Response, or Extensible Authentication Protocol over LAN (EAPOL) Key frame transmitted by an AP MLD of the SMD.

5. The method of claim 1, wherein the SMD element comprises an SMD identifier of the SMD which is an MAC address, the information of the target AP MLD including the SMD identifier.

6. The method of claim 5, wherein the SMD identifier is used for identifying the SMD and a non-AP MLD associates with a serving AP MLD of the SMD based on the SMD identifier.

7. The method of claim 5, wherein the SMD identifier is used for identifying the SMD, a non-AP MLD does authentication with a serving AP MLD of the SMD, and the SMD identifier is used as an authenticator MAC address for pairwise transient key (PTK) creation.

8. The method of claim 1, wherein a Neighbor Report element carries the SMD element to identify an SMD to which a candidate target AP MLD belongs.

9. The method of claim 1, wherein a Neighbor Report element carries an indication whether the candidate target AP MLD in the Neighbor Report element and a reporting AP MLD belongs to a same SMD.

10. The method of claim 1, further comprising sending a roaming request to a single selected candidate target AP MLD to do roaming preparation.

11. The method of claim 1, further comprising receiving a basic service set (BSS) transition message (BTM) request having a neighbor report element with service requirements of the one or more candidate target AP MLDs and sending a BTM response to indicate the candidate target AP MLDs that meet defined service requirements.

12. The method of claim 1, wherein the one or more candidate target AP MLDs are identified by AP MLD identifiers in an AP MLD ID space not used by another AP MLD in a same AP device as a reporting AP MLD or by links of the reporting AP MLD in the AP device which is not one of the candidate target AP MLDs.

13. The method of claim 1, further comprising transmitting a BTM query by a non-AP MLD having an indication that a query is for candidate target AP MLDs in a same SMD as a recipient AP MLD.

14. The method of claim 13, further comprising the BTM query indicates service requirements of a non-AP MLD different from services provided by a serving AP MLD.

15. The method of claim 1, further comprising establishing a resource reservation with the target AP MLD by a resource reservation element which comprises an identification of the target AP MLD in an action details field of the resource reservation element.

16. The method of claim 1, wherein a Link Reconfiguration Request and Response are used to establish links with the target AP MLD.

17. The method of claim 16, wherein the Link Reconfiguration Request and Response are used as a roaming preparing request and roaming preparing response.

18. A non-AP MLD in a seamless mobile domain (SMD) of a wireless network, the non-AP MLD arranged to receive from an access point multi-link device (AP MLD) in the wireless network information of one or more candidate target AP MLDs to seamlessly roam to, the information including a seamless roaming domain (SMD) element that identifies a respective seamless roaming domain of the one or more candidate target AP MLDs; select a target AP MLD from the one or more candidate AP MLDs based on the information; and roam to the target AP MLD.

19. The non-AP MLD of claim 18, wherein the SMD element is carried in an Association Response, Authentication Response, or Extensible Authentication Protocol over LAN (EAPOL) Key frame transmitted by a serving AP MLD of the SMD.

20. The non-AP MLD of claim 18, wherein the SMD element comprises an SMD identifier of the SMD which is an MAC address, the information of the target AP MLD including the SMD identifier.

21. The non-AP MLD of claim 18, wherein a Neighbor Report element carries the SMD element to identify a SMD to which a candidate target AP MLD belongs.

22. The non-AP MLD of claim 18, wherein a Neighbor Report element carries an indication whether the candidate target AP MLD in the Neighbor Report element and a reporting AP MLD belongs to a same SMD.

23. The non-AP MLD of claim 18, wherein the one or more candidate target AP MLDs are identified by AP MLD identifiers in an AP MLD ID space not used by another AP MLD in a same AP device as a reporting AP MLD or by links of the reporting AP MLD in the AP device which is not one of the candidate target AP MLDs.

24. The non-AP MLD of claim 18, further arranged to establish a resource reservation with the target AP MLD by a resource reservation element which comprises an identification of the target AP MLD in an action details field of the resource reservation element.

25. The non-AP MLD of claim 18, wherein a Link Reconfiguration Request and Response are used to establish the links with the target AP MLD.
